(19) United States
(12) Patent Application Publication
(10) Pub. No.: US 2003/0183053 A1
(43) Pub. Date: Oct. 2, 2003

(54) Rotary apparatus and related method

(76) Inventors: Alfred R. Amend, Kendall Park, NJ (US); Jonathan M. Hansen, Ewing, NJ (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/108,824

(22) Filed: Mar. 28, 2002

(51) Int. Cl. B26D 1/62

(52) U.S. Cl. 83/13; 83/344

(57) ABSTRACT

This invention relates to a rotary apparatus and related methods for pressing or cutting articles. More specifically, this invention relates to a rotary pressing assembly configured to reduce the stress upon the pressing member when performing a pressing operation on articles which have a variation in surface area, density or thickness. Even more specifically, this invention relates to a rotary knife assembly configured to reduce the stress upon the knife blade while cutting a plurality of articles from a sheet or web of material.

### FIELD OF THE INVENTION

This invention relates to a rotary apparatus and related methods for pressing or cutting articles. More specifically, this invention relates to a rotary pressing assembly configured to reduce the stress upon the pressing member when performing a pressing operation on articles which have a variation in surface area, density or thickness. Even more specifically, this invention relates to a rotary knife assembly configured to reduce the stress upon the knife blade while cutting a plurality of articles from a sheet or web of material.

### BACKGROUND OF THE INVENTION

A typical rotary knife can be described as a “cookie cutter” wrapped three-dimensionally around a cylinder to form a knife roll. The cylindrical cutting surface of the knife roll is pushed into intimate contact with an anvil roll. Material that is fed between the knife roll and the anvil roll is progressively “crush-cut” or “die-cut.” A sharpened cutting edge of the knife roll typically has a flat width of between about 0.002″ (0.005 cm) to about 0.004″ (0.010 cm) and an included angle of between 60° and 110°. When such a knife cutting edge makes peripheral cuts, the surface area of the material being cut varies. This variation is significant between end cut regions relative to side cut regions. Since the loading on the knife cutting edge changes in direct proportion to the area being cut, the knife cutting edge is under higher stress while cutting a smaller surface area of material. This situation leads to a shortened knife roll life as this repeated stress causes damage to the knife cutting edge.

Ideally, during the progressive cutting action of the knife-edges, the cutting pressure (P) should remain constant. Cutting pressure is a function of the force (F) per unit area (A) as per the following mathematical relationship:

P=F/A

With constant cutting pressure, stress (σ) on the knife material also would remain constant.

The instantaneous area of cut, which is the area of knife-edge in contact with the anvil roll, changes significantly due to the varying shape(s) of the products being cut. For example, a greater area of cut is found typically when the knife-edge is predominantly aligned with the rotational axis of the knife roll (usually, at the end cut knife-edge region). Conversely, a significantly smaller area of cut occurs when the knife-edge is predominantly aligned perpendicularly to the rotational axis of the knife roll (usually, at the side cut knife-edge region). The ratio of these instantaneous cut areas can typically be as great as 40: 1, depending upon how the area is measured. This variation in instantaneous area of cut corresponds to variations in stress on the knife material—when the area is the greatest the stress is the lowest and vice versa.

Additional force is required to make the end-cuts where the area of cut is large (where the cutting edges are predominantly parallel to the rotational axis of the knife). That is, the force on the knife-edge must be made sufficiently large to yield satisfactory cuts being made in this end-cut region. This force generated by the loading mechanism is typically applied on the bearing journals at each side of the roll's working surface.

Once that force is set for the knife apparatus, it remains constant throughout each cutting operation. As a result, when the knife apparatus is performing cuts in a side region, and the area of cut is small, the pressure on this section of the knife blade is significantly increased. A further consequence is that barring catastrophic failure, knives nearly always prematurely fail at this side cut section.

The above discussion addressed variations in knife-edge pressure relating to variations in the surface area being cut. These pressure variations also occur where, for example, a finished product is being cut and that article has variations in thickness, density, or composition of materials in the area being cut. Any variations in pressure on the knife cutting edge contribute to the above described stress and premature failure of the knife.

In addition to the direct cost of repair or replacement of the knife roll, premature failure of a knife cutting edge has additional associated costs. One example of which is the down time required for the replacement and adjustment of the new knife roll. In a high-speed line operation this down time may result in a significant cost factor. Further, a cutting operation failure may necessitate discarding partially completed products along the line. This also may be significant depending upon the value of the product being produced. Clearly, a need exists to reduce the premature failure of rotary knives.

Various methods have been used to address this premature failure of rotary knife blades. Typically, these include use of damping materials in the fabrication of the rotary modules, using stronger materials such as tungsten carbide in the construction of the knife, and also by using peripheral devices such as air cylinders, springs, and mechanical devices incorporating load cells and automatic feedback controls (cf. U.S. Pat. No. 6,158,316 issued Dec. 12, 2000 to Ichikawa et al., U.S. Pat. No. 4,364,293 issued Dec. 21, 1982 to Hirsch, U.S. Pat. No. 4,962,683 issued Oct. 16, 1990 to Scheffer et al., and WIPO Publication WO 01/19573 dated Mar. 22, 2001). These methods have met with limited success. While use of expensive, stronger materials, such as tungsten carbide, seem to reduce the effects of the problem in some situations, the ability for these materials to satisfactorily compensate for stress variations are frequently exceeded.

The present invention overcomes these problems of the conventional technology as described above by modifying the bearer rings of a rotary knife apparatus in a way that results in reduced variations in stress on a rotary knife's cutting edge and thereby prolongs the life of the knife roll.

Further, the present invention is applicable to any rotary pressing operation in which bearer rings are employed. That is, the invention reduces variations in stress on a pressing head. Reduction of these variations reduces wear on the pressing head and thereby prolongs its life. Further, it results in a more uniform pressing operation yielding, for example in a channeling operation, a more uniform depth of channels.

### SUMMARY OF THE INVENTION

It is an object of this invention to reduce stress variations upon a pressing head in a rotary pressing operation. Particularly, it is an object of this invention to modify the bearer rings of a rotary pressing apparatus to provide increased pressure at select locations when it is needed in the rotary pressing operation. More particularly, it is an object of this invention to modify the bearer rings of a rotary knife apparatus to reduce stress on the knife blade during the cutting of areas of reduced surface area.

In accordance with the present invention, there is provided a rotary knife apparatus for performing a cutting operation on a material, the rotary knife apparatus comprising a knife roll comprising a rotary shaft, wherein the rotary shaft comprises a rotational axis and an outer perimeter, wherein the outer perimeter comprises at least one knife blade and two bearer rings positioned on opposite sides of the knife blade; an anvil roll positioned such that a contact area exists between the anvil roll and each of the bearer rings, and further positioned such that during the cutting operation, pressure exists between the anvil roll and at least a part of the knife blade and between the anvil roll and each contact area; and, means for adjusting the pressure between the knife blade and the anvil roll by modifying at least one of the contact areas.

Also provided in accordance with the present invention is a rotary apparatus for performing a pressing operation on a material which is positioned between a pressing member and an anvil roll, the rotary apparatus comprising a first rotary member comprising a rotary shaft, wherein the rotary shaft comprises a rotational axis and an outer perimeter, wherein the outer perimeter comprises the pressing member and two bearer rings positioned on opposite sides of the pressing member; the anvil roll positioned such that during the pressing operation, a contact area exists between the anvil roll and each of the bearer rings, and further positioned such that pressure exists between the anvil roll, at least a part of the pressing member, and the material; and, a means for adjusting the pressure by modifying at least one of the contact areas.

Still further provided in accordance with the present invention is a method for performing a pressing operation on a material which is positioned between a pressing member and an anvil roll, said method comprising the steps of providing a first rotary member comprising a rotary shaft, wherein the rotary shaft comprises a rotational axis and an outer perimeter, wherein the outer perimeter comprises the pressing member and two bearer rings positioned on opposite sides of the pressing member; the anvil roll positioned such that during the pressing operation a contact area exists between the anvil roll and each of the bearer rings, and further positioned such that pressure exists between the anvil roll, at least a part of the pressing member and the material; and, adjusting the pressure by modifying at least one of the contact areas.

### BRIEF DESCRIPTION OF THE DRAWINGS

While the specification concludes with claims particularly pointing out and distinctly claiming the present invention, it is believed that the present invention will be better understood from the following description in conjunction with the following drawings, in which like reference numbers identify identical elements and wherein:

FIG. 1a is a schematic of a rotary knife apparatus;

FIG. 1b is a cross-sectional view of a typical rotary knife apparatus depicted in FIG. 1a, illustrating examples of minimum knife-edge contact area and maximum knife-edge contact area;

FIG. 2 illustrates in both table and graph form the knife cut segment area as a function of the distance from the product end;

FIG. 3 is a plan view of the knife/bearer ring surface of an embodiment the present invention;

FIG. 4a is a detailed plan view of a bearer ring notch;

FIG. 4b is a cross-sectional view of the notch of FIG. 4a taken through the lines A-A;

FIG. 5 is a plan view of the knife/bearer ring surface of an alternative embodiment the present invention;

FIG. 6 is a plan view of the heat seal roll bearer ring surface of an alternative embodiment the present invention;

FIG. 7 is a plan view of the heat seal roll bearer ring surface of an alternative embodiment the present invention;

FIG. 8 is a plan view of the channeling bearer ring surface of an alternative embodiment of the present invention;

FIG. 9 is a plan view of the channeling bearer ring surface of an alternative embodiment of the present invention; and

FIG. 10 is a plan view of the channeling bearer ring surface of an alternative embodiment of the present invention.

### DETAILED DESCRIPTION OF THE INVENTION

The present invention is employed to reduce stress variations upon a pressing head in a rotary pressing operation. This is achieved by modifying the bearer rings of a rotary pressing apparatus to provide increased pressure at select locations when it is needed in the rotary pressing operation. The following detailed description will first address this invention as it relates to a rotary knife apparatus.

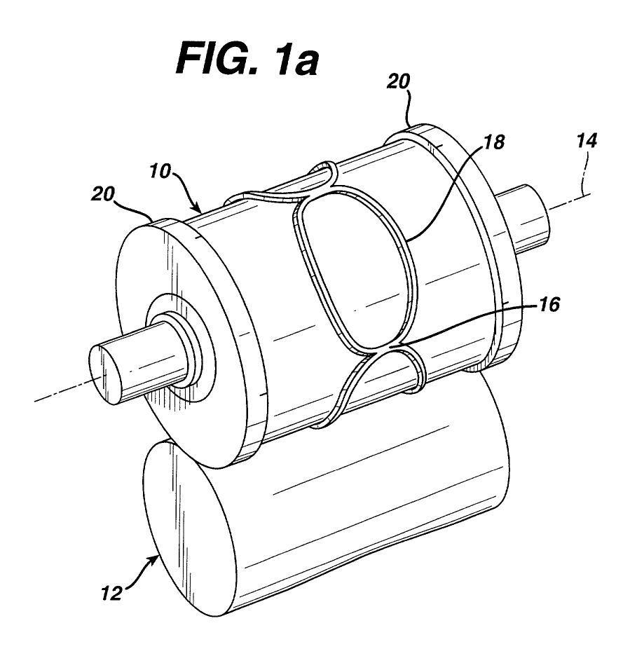

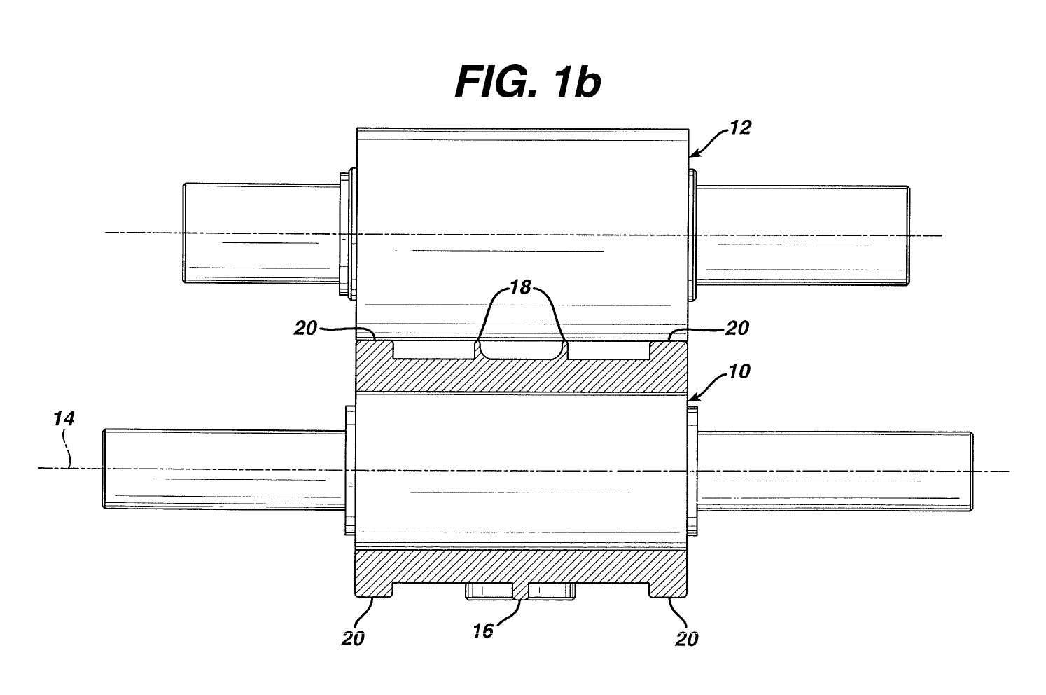

FIG. 1a depicts a typical rotary knife apparatus for use in the manufacture of sanitary napkins. For the sake of simplification of the following discussion, we will only address the situation depicted in FIG. 1a where the end cut region 16 is parallel to the rotational axis 14. Of course, if the napkins were being cut in a transverse direction, the greatest area of knife blade stress would then be on the long edge (now oriented in the direction parallel to the rotational axis) and a similar analysis would apply.

FIG. 1b is a cross-sectional view of this rotary knife where the side cut section of the knife blade 18 is in contact with the anvil roll 12. This represents the minimum area of cutting contact. For comparison the end cut knife-edge 18, the maximum area of contact, is also depicted in this FIG. 1b. It should be noted that FIG. 1b shows these minimum and maximum areas positioned 180° relative to each other. This angular relationship may be different in real-life situations.

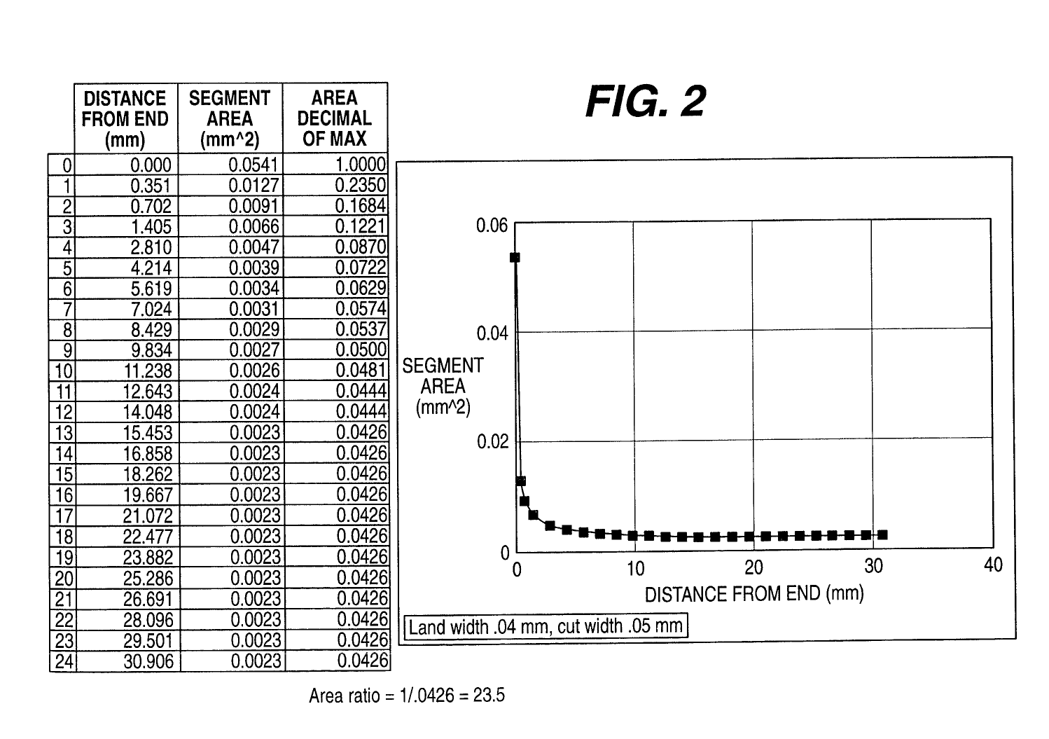

FIG. 2 graphically depicts in tabular and graphical form how significantly the area being cut (knife cut segment area) varies. At the end of the product (a tangent to which is parallel to rotational roll axis) the area is high. The area drops very quickly to a much lower value as a function of distance from the end cut. It is interesting to note that the area ratio increases as the radius of curvature of the cut perpendicular to the roll axis approaches infinity. The worst case (highest area ratio) would yield a rectangular product where a straight end cut that is parallel to the rotational axis of the knife roll. The best case (lowest area ratio) is a product whose end radius is zero, and the end of the product comes to a point.

An easy proof that this phenomenon occurs is that when a new knife has not yet been fully loaded to make a complete cut, only those areas perpendicular to the roll axis will cut the material. Complete cutting is accomplished by increasing the load between the knife roll and the anvil roll. If the area of cut were constant then the entire knife surface would cut all at once and no additional adjustment (load increase) would be necessary.

Accordingly, a minimum level of loading of the knife needs to be attained to permit satisfactory cutting of regions having relatively high surface area. However, increasing the loading between the knife roll and the anvil roll results in disruptions to the overall system. Energy is stored in the members that make-up the rotary knife apparatus. For example, the loading screws or the air cylinder rods compress and shorten, the top plate bends, the four posts stretch, the rolls bend away from each other, the bearer rings form flat areas where they touch the anvil roll, etc. Each mechanical part has a Modulus of Elasticity, a Poisson's ratio and many varying cross-sections and configurations. All yield and deflect some amount (x) under load. Each part may be thought of as a spring having a spring constant (k). The total knife apparatus being composed of many such springs, some in series and others in parallel to each other. The basic mathematical relationship of a spring is Hooke's law that follows the relationship:

F=kx

If one were to mathematically add together all the spring deflections, one could arrive at one resultant spring that equaled all the others put together. Using the deflection of that one spring, one can compute the resultant work done by the spring on a body that compresses it as the product of the average force and that deflection, i.e.:

E=½(kx²)

There are two relevant conditions: (1) the force required to cut the product sides (being relatively small) and (2) the increased force to cut the product ends (being relatively large). The additional energy that is required to generate the force necessary to cut the end of the product is momentarily stored in the knife system spring(s). As the knife roll rotates to a lower knife contact area (having reduced product area to be cut), this stored energy is dynamically “reflected” back onto the reduced-area knife-edge material. In this way it is possible to exceed the elastic limit of the knife and/or anvil material at the reduced area of contact thereby resulting in damage and reducing knife-life.

One possible solution to this problem is to make a rotary knife system that is exceedingly stiff with a very high overall spring rate. In this way, in the relationship P=F/A as the area (A) changes the force (F) would automatically change also, thereby keeping the cutting pressure (P) a constant. Since the deflection (x) of the combined spring would be very small, very little extra energy would be stored to provide for the increased force required to cut the ends of the product. This solution is difficult to achieve and would result in an enormously ungainly module, very difficult to maintain in present machines.

When stored energy is considered it is assumed that there is movement in the system. The deflection (x) of the various parts comprising the rotary knife module has already been discussed. One can imagine that all the elastic members move, “breathe” up and down, in and out, as the dynamic cutting force change as a function of cutting area. One embodiment of the present invention addresses this problem by utilizing a particular elastic deformation—the deformation of the cylindrical surfaces of the bearer rings against the anvil roll. When two cylinders are pressed against each other under load, two things occur:

1. A flat area is generated whose width (2b) can be calculated as a function of the face-width (L) of the shorter cylinder, the net force (F) pressing them together, the diameters of the two cylinders (D1, D2), the modulus of elasticity of each of the cylinders (E1 , E2) and their Poisson's ratio (v1, v2)

2. Corresponding to the flat area generated, the axes of the two cylinders approach each other by the amount (Δx).

The mathematical relationship of these parameters can be expressed in the following formulae (from Standard Handbook of Machine Design, Joseph E. Shigley and Charles R. Mischke, McGraw Hill 1986, page 13-41):

$$b = \sqrt{\frac{( 2 \cdot F )}{( π \cdot L )} \cdot \frac{\frac{( 1 - {v1}^{2} )}{E1} + \frac{( 1 - {v2}^{2} )}{E2}}{( \frac{1}{D1} ) + ( \frac{1}{D2} )}}$$

$$Δ x = \frac{2 \cdot F}{π \cdot L} \cdot [ \frac{( 1 - {v1}^{2} )}{E1} + \frac{( 1 - {v2}^{2} )}{E2} ] \cdot [ ln ( \frac{D1}{b} ) + ln ( \frac{D2}{b} ) + \frac{2}{3} ]$$

Dynamically, the flat cylinder interface width (2b) and the corresponding change in cylinder distance (Δx) move continually between the two conditions. The load sharing between the bearer rings and the knife cutting edges are also very dynamic and difficult to determine.

In an embodiment of the present invention the face width of the bearer rings is selectively modified so that the load sharing between the bearer rings and the cutting edges result in a satisfactory cutting pressure. That is, by reducing the bearer ring width as the end-cut is made, the force on the bearer ring is suddenly distributed over a smaller area thus increasing the flat-spot width (2b) and decreasing the distance between anvil and knife roll axes (Δx). This results in the temporary shifting more of the load onto the knife cutting surfaces when it is required.

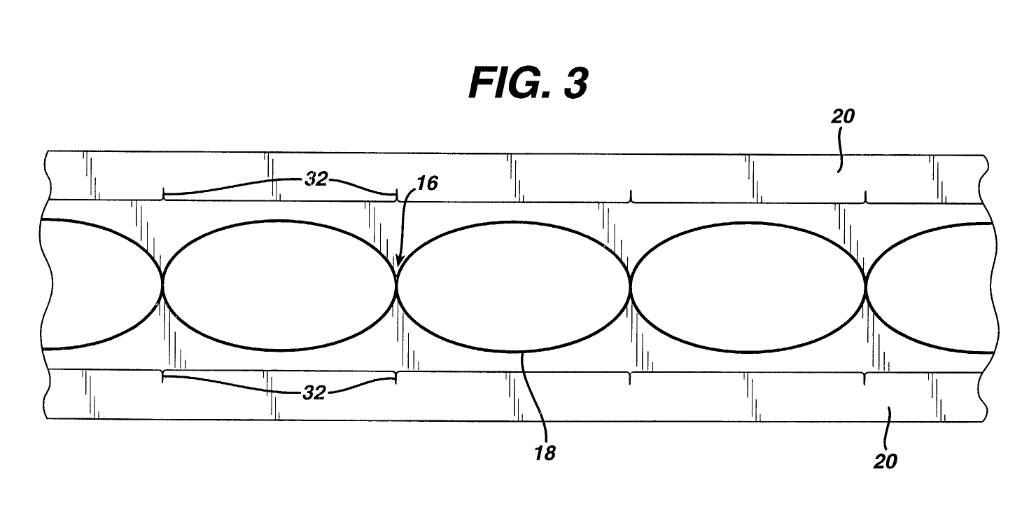

This embodiment of the invention in which the bearer ring face width is so modified is depicted in FIG. 3. FIG. 3 illustrates an “opened” view of the bearer ring 20 and knife surface. As shown notches 32 appear in each of the bearer rings at selective locations that coincide with the end cut knife-edge 16. This results in additional pressure being applied to the knife-edge to perform cuts of areas of increased surface area. It should be noted that similarly, increased pressure could be selectively applied to perform cutting of specific areas of increased thickness and/or density.

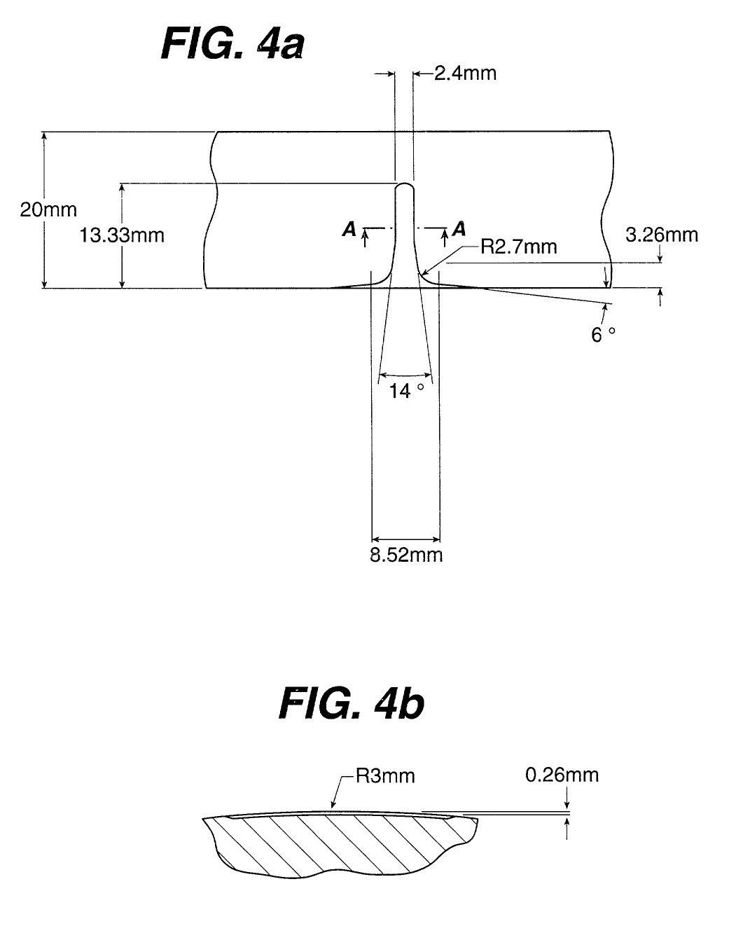

FIGS. 4a and 4b depict detail dimensions of these notches in a further embodiment of the invention based on a 30 mm wide bearer ring. These dimensions are based upon a Finite Element Analysis (FEA) modeling of stresses during a cutting operation using a typical knife roll-anvil roll combination as depicted in FIG. 1. The notches, or reduced surfaces, are quite narrow due to the sudden change in cutting surface area and are shaped to correspond to the graph in FIG. 2.

An additional feature of the embodiment of the invention depicted in FIG. 4a is the presence of a ramped opening 42 to the bearer ring notch 32. As this section of the bearer ring rotates into contact with the anvil roll this ramping lessens the severity of the change in bearing ring surface area and consequently change in resulting force. Further, the presence of a symmetrical ramp at the opposing side of the notch reduces the impact of the knife roll against that edge as it rotates past the notch. That is, this ramping is employed to reduce the shocks to the system not unlike a car tire entering and exiting a pothole.

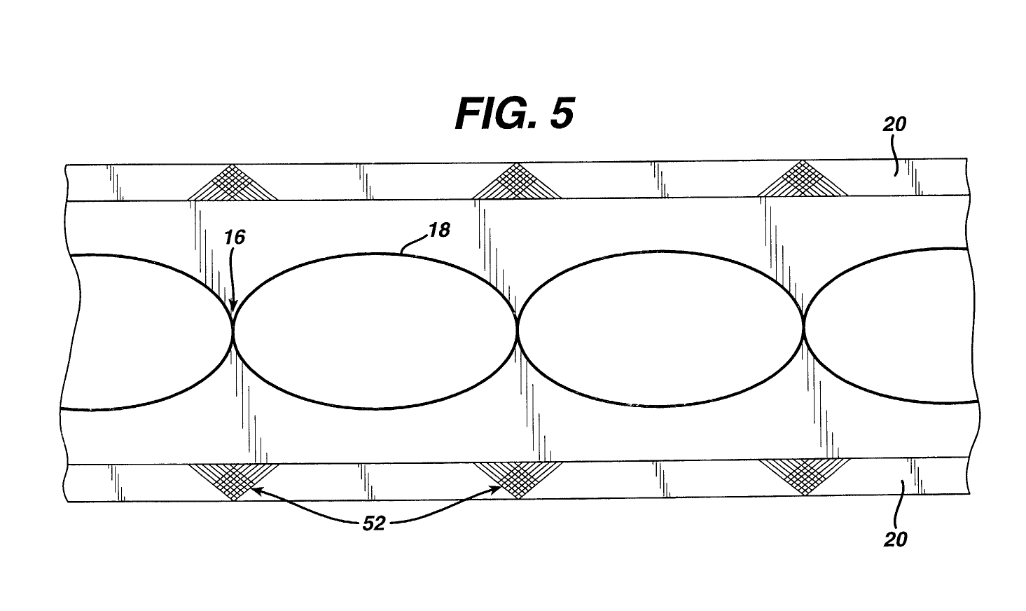

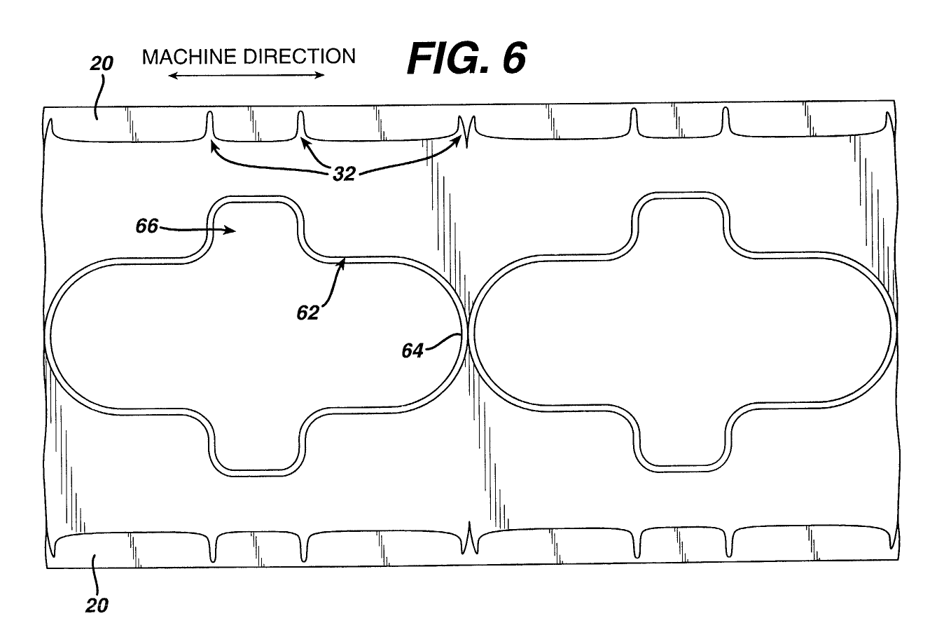

The reduced surface areas of the bearing rings are not limited to the notches depicted in FIG. 3. In particular, the configuration of the reliefs in the bearer rings can be changed in amount, size and orientation to create different ratios of area reduction. This may or may not exactly match the load sharing between the bearer rings and the cutting edges, but helps reduce the difference between the required cutting pressures for various points of the cutting edge. By way of example, an alternative embodiment of the invention is depicted in FIG. 5 wherein the reduced surface area of the bearer rings is attained by a cross hatch pattern 52 located on the bearer ring surface at the appropriate locations.

A further alternative embodiment (not pictured) reduces the area of contact between the anvil and the bearer rings by modifying the anvil roll surface. That is, a configuration of relieved areas on the anvil roll surface (with or without modifying the bearer rings) would be employed. An example of which would be cross-hatched areas. Although any relieved anvil surface that modifies the anvil surface to create depressed areas and thereby reduces the surface area of contact with the anvil roll would yield the same beneficial results provided these areas were appropriately positioned and timed to coordinate with the variations in cutting surface areas. It is well known in the art to perform such timing coordination by means of gears or belts.

While the above discussions address embodiments in which a cutting operation is being performed, the present invention is not so limited. In particular, it is envisioned that any operation employing bearer rings in which a pressing operation is performed against an anvil can make use of the present invention. Examples of such operations are cutting, scoring, sealing, rolling, embossing, channeling, crimping, calendering, and the like. As with the cutting operation, the invention would minimize variations in pressure that occur as a result in variations of the surface area of the material being operated upon. This would help minimize stress and wear on the heads performing the operation and yield a more even application on the resulting product.

For example, FIG. 6 depicts a heat sealing operation being performed on women's sanitary napkins. In particular, FIG. 6 is an opened view of a heat seal roll with scalloped or notched bearer rings. As in the cutting operation illustrated in FIG. 3, notches 32 appear in each of the bearer rings 20 to coincide with end of napkin regions 64 to thereby increase pressure on the heat sealing head at this location. This increase in pressure is being applied at these locations to correlate with the increased surface area of the material being sealed. Similarly, increased pressure is provided, via additional notches 32, to heat seal the increased surface area of the napkin wing edges that are essentially perpendicular to the machine direction.

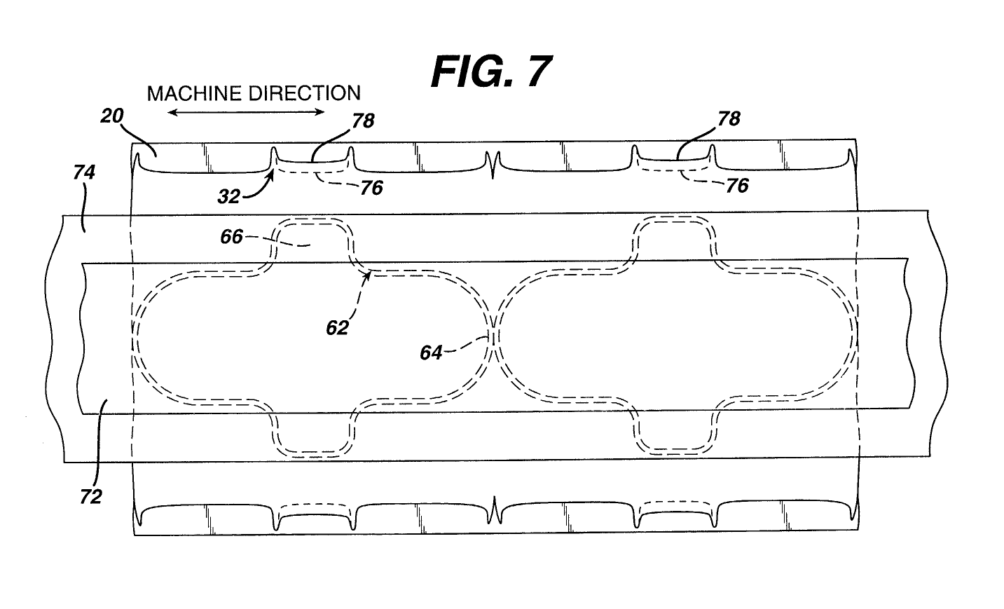

FIG. 7 illustrates another embodiment of the invention which addresses changes in material thickness in a heat sealing operation. FIG. 7 depicts a heat sealing operation being performed on sanitary napkins. In such a heat sealing operation, the heat seal head lies beneath the bearer ring surfaces. In this manner pressure is applied to the material being sealed without the heat seal head coming in contact with the anvil roll. This differs from the knife cutting operation depicted in FIG. 1b, in which the knife edge 18 is essentially on the same level of the bearer ring surface 20.

A problem occurs in the sealing operation when a material of decreased thickness is encountered. The distance between the heat seal head and the anvil roll may be too large to permit a satisfactory seal. Depending on the thickness variation, it may be possible to adjust the apparatus by increasing pressure to satisfactorily address the areas of smaller thickness. However, such an adjustment will result in larger stresses on the heat sealing head when thicker areas are sealed. This results in reduced head life and a less uniform sealing operation.

The embodiment of the invention depicted in FIG. 7 adjusts for design differences in thickness of the material to be heat sealed by modifying the bearer rings. The illustrated sanitary napkins comprise two materials, items 72 and 74. Item 74 is present throughout the napkin will item 72 is added essentially to the central region of the napkin. Thus, the napkin wing area 66 has a reduced thickness as it does not contain material 72.

As in FIG. 6, notches are provided to yield increased pressure when increased surface area is being embossed (e.g., the napkin end region 64). In addition, there is an area of reduced width of the bearer rings 78 to compensate for the reduced thickness of the wing area 66. That is, the width of the bearer ring is reduced from the width 76 used in a uniformly thick napkin, to a reduced width 78. As discussed above with respect to a knife edge, reducing the bearer ring width in this manner results in the force on the bearer ring being suddenly distributed over a smaller area thus increasing the flat-spot width (2b) and decreasing the distance between anvil and the heat seal head (Δx). In this manner the present invention adjusts to perform heat sealing of reduced thickness of material.

This aspect of the invention is not just applicable to heat sealing. It is envisioned that this feature of the invention can be employed in other sealing operations as well as operations related to rolling, embossing, channeling, scoring, crimping and calendering.

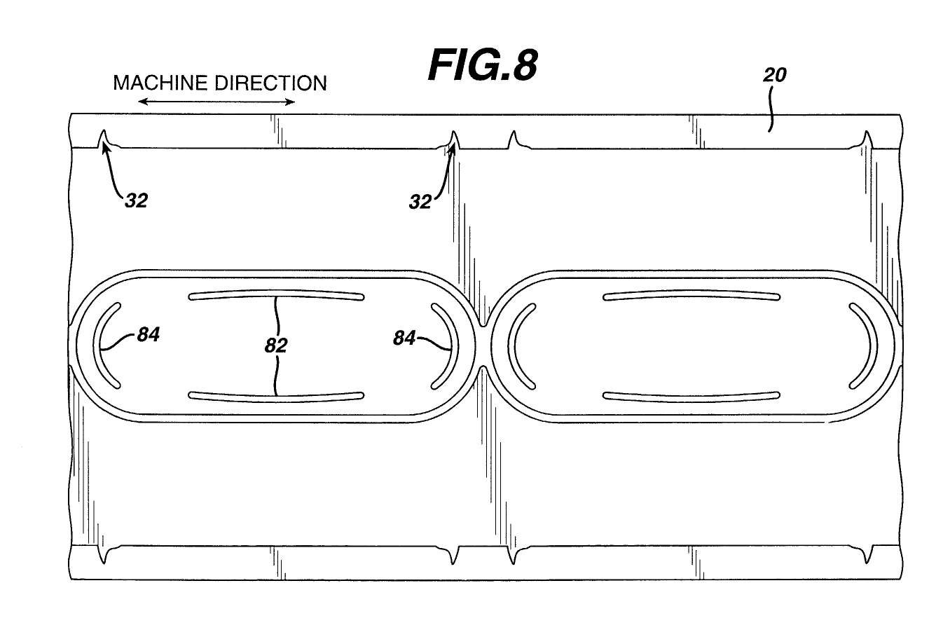

FIG. 8 illustrates such an additional embodiment of the invention in which channeling is being performed. In this embodiment two types of channels areas are depicted—areas 82 essentially occurring in the machine direction, and areas 84 essentially occurring in a direction perpendicular to the machine direction. As with the cutting and sealing operations discussed above, additional pressure is required to channel the larger surface areas associated with areas 84. This embodiment of the invention again employs notches 32 in the bearer rings 20 to provide additional pressure at only the 84 areas as the napkin is being channeled.

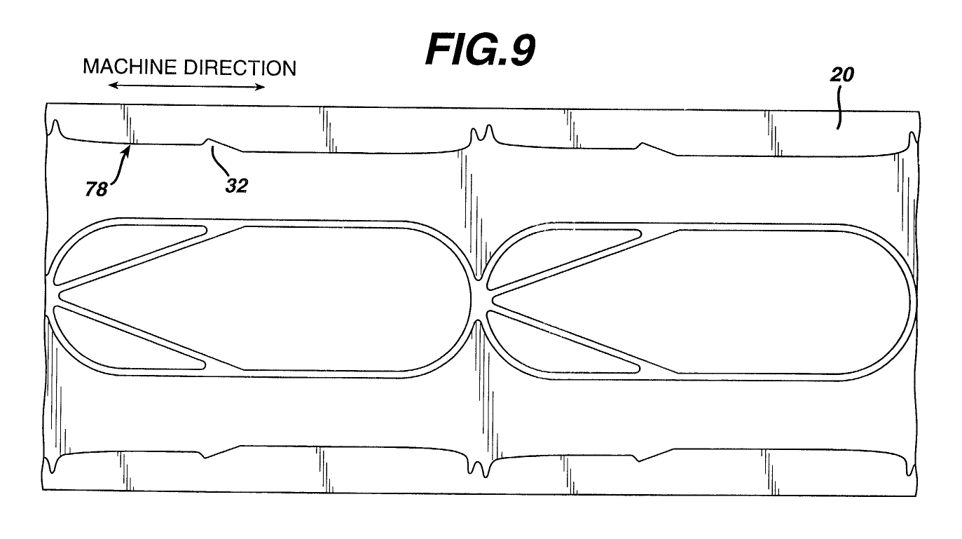

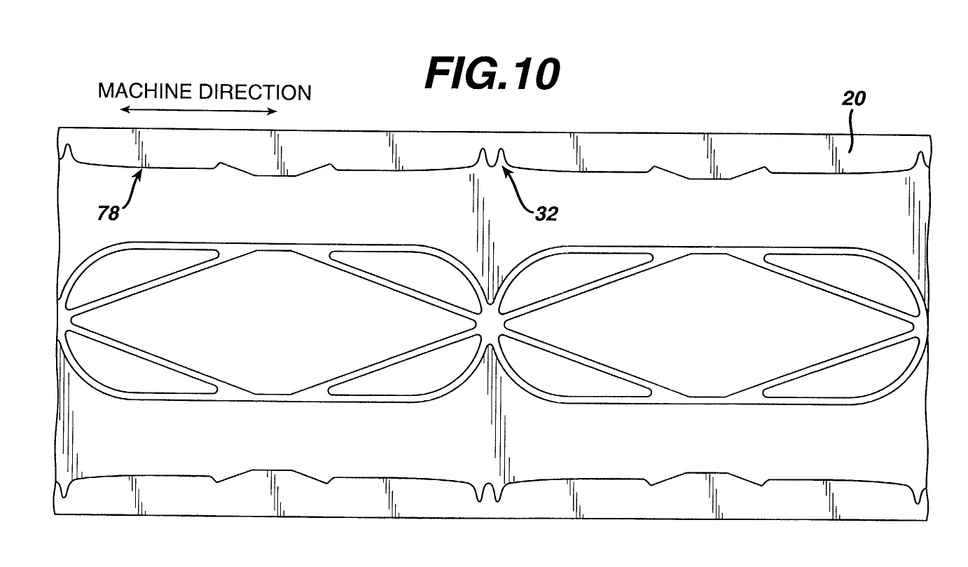

FIGS. 9 and 10 illustrate additional embodiments of the invention in which channeling is being performed. In these Figures more complicated patterns are being channeled and pressure on the channeling head is adjusted by a combination of notches 32 and areas of reduced bearer ring width in a manner analogous to the sealing operation depicted in FIG. 7.

While the above description of the invention related chiefly to the construction of sanitary napkins, the invention is not limited to sanitary napkins nor to the particular materials used in sanitary napkin construction. It is envisioned that the present invention is applicable to any operation utilizing a pressing operation against an anvil roll where bearer rings are employed. Such an anvil roll need not be a smooth surface, as by way of example, male/female embossing is contemplated by the invention. Further, the present invention is applicable to a wide variety of materials, including, but not limited to, foils, plastics, nonwovens, paper goods, and miscellaneous rolled goods.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A rotary knife apparatus for performing a cutting operation on a material, said rotary knife apparatus comprising:
a) a knife roll comprising a rotary shaft, wherein the rotary shaft comprises
a rotational axis and
an outer perimeter,
wherein the outer perimeter comprises
at least one knife blade and
two bearer rings positioned on opposite sides of the knife blade;
b) an anvil roll positioned such that during the cutting operation a contact area exists between the anvil roll and each of the bearer rings, and further positioned such that pressure exists between the anvil roll and at least a part of the knife blade; and,
c) wherein the pressure is adjusted between the knife blade and the anvil roll by modifying at least one of the contact areas.

2. The rotary knife apparatus of claim 1 wherein during the cutting operation the material has a varying surface area in contact with the knife blade and the modifying at least one of the contact areas is performed to at least partially compensate for said varying surface areas.

3. The rotary knife apparatus of claim 1 wherein for each of said bearer rings, the contact area is reduced in at least one location to thereby increase pressure on the knife blade.

4. The rotary knife apparatus of claim 3 wherein the contact area is reduced by reducing the face width of the bearer ring.

5. The rotary knife apparatus of claim 3 wherein the contact area reduced by cross-hatching the face of the bearer ring.

6. The rotary knife apparatus of claim 3 wherein the at least one location of the reduced contact area is located to coincide with the knife blade performing a cutting of increased surface area of the material.

7. The rotary knife apparatus of claim 3 wherein the contact area is reduced by positioning a relieved surface on the anvil roll.

8. A rotary apparatus for performing a pressing operation on a material, the material being positioned between a pressing member and an anvil roll, the rotary apparatus comprising:
a) a rotary member comprising a rotary shaft, wherein the rotary shaft comprises
a rotational axis and
an outer perimeter,
wherein the outer perimeter comprises
the pressing member and
two bearer rings positioned on opposite sides of the pressing member;
b) the anvil roll positioned such that during the pressing operation, a contact area exists between the anvil roll and each of the bearer rings, and further positioned such that pressure exists between the anvil roll, at least a part of the pressing member, and the material; and,
c) means for adjusting the pressure by modifying at least one of the contact areas.

9. The rotary apparatus of claim 8, wherein the pressing operation is selected from the group consisting of cutting, scoring, sealing, rolling, embossing, channeling, crimping and calendering.

10. The rotary apparatus of claim 8 wherein during the pressing operation the material has a varying surface area in contact with the pressing member and said means for adjusting the pressure is performed to at least partially compensate for said varying surface areas.

11. The rotary apparatus of claim 8 wherein for each of said bearer rings, the contact area is reduced at at least one location to thereby increase the pressure.

12. The rotary apparatus of claim 11 wherein the contact area is reduced by reducing the face width of the bearer ring.

13. The rotary apparatus of claim 11 wherein the contact area is reduced by cross-hatching the face of the bearer ring.

14. The rotary apparatus of claim 11 wherein the at least one location of the reduced contact area is located to coincide with the pressing member performing the pressing operation upon an increased surface area of the material.

15. The rotary apparatus of claim 11 wherein the at least one location of the reduced contact area is located to coincide with the pressing member performing the pressing operation upon an increased thickness of the material.

16. The rotary apparatus of claim 11 wherein the at least one location of the reduced contact area is located to coincide with the pressing member performing the pressing operation upon an increased density of the material.

17. The rotary apparatus of claim 11 wherein the contact area is reduced by positioning a relieved surface on the anvil roll.

18. A method for performing a pressing operation on a material, the material being positioned between a pressing member and an anvil roll, said method comprising the steps of:
a) providing a rotary member comprising a rotary shaft, wherein the rotary shaft comprises
a rotational axis and
an outer perimeter,
wherein the outer perimeter comprises
the pressing member and
two bearer rings positioned on opposite sides of the pressing member;
b) positioning the anvil roll such that during the pressing operation, a contact area exists between the anvil roll and each of the bearer rings, and further positioned such that pressure exists between the anvil roll, at least a part of the pressing member and the material; and,
c) adjusting the pressure by modifying at least one of the contact areas.

19. The method of claim 18, wherein the pressing operation is selected from the group consisting of cutting, scoring, sealing, rolling, embossing, channeling, crimping and calendering.

20. The method of claim 18 wherein during the pressing operation the material has a varying surface area in contact with the pressing member and said step of adjusting the pressure is performed to at least partially compensate for said varying surface areas.

21. The method of claim 18 wherein for each of said bearer rings, the contact area is reduced at at least one location to thereby increase pressure.

22. The method of claim 21 wherein the contact area is reduced by reducing the face width of the bearer ring.

23. The method of claim 21 wherein the contact area is reduced by cross-hatching the face of the bearer ring.

24. The method of claim 21 wherein the at least one location of the reduced contact area is located to coincide with the pressing member performing the pressing operation upon an increased surface area of the material.

25. The method of claim 21 wherein the at least one location of the reduced contact area is located to coincide with the pressing member performing the pressing operation upon an increased thickness of the material.

26. The method of claim 21 wherein the at least one location of the reduced contact area is located to coincide with the pressing member performing the pressing operation upon an increased density of the material.

27. The method of claim 21 wherein the contact area is reduced by positioning a relieved surface on the anvil roll.
